(19) United States
(12) Patent Application Publication
(10) Pub. No.: US 2010/0204831 A1
(43) Pub. Date: Aug. 12, 2010

(54) PROCESS FOR MONITORING AND REGULATION OF AN INDUSTRIAL UNIT THAT EMPLOYS A CLOSED-LOOP IDENTIFICATION PHASE FOR THE OPERATING PARAMETERS OF SAID UNIT

(75) Inventors: Nicolas Couenne, Lyon (FR); Jean Marc Bader, Taluyers (FR); Yann Creff, Les Coles D'Arey (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: IFP, RUEIL-MALMAISON CEDEX (FR)

(21) Appl. No.: 12/700,808

(22) Filed: Feb. 5, 2010

(30) Foreign Application Priority Data
Feb. 6, 2009 (FR) 09/00531

(51) Int. Cl. G05B 13/04; G05B 23/02

(52) U.S. Cl. 700/272; 700/30

(57) ABSTRACT

This invention describes a new process for monitoring and regulation of an industrial unit that comprises a closed-loop identification phase for the parameters of a model of said industrial unit, implemented in a multi-variable, predictive linear monitor, whereby said identification phase is implemented in a closed loop, which makes it possible to minimize the substandard production of said unit.

### FIELD OF THE INVENTION

The field of the invention is that of advanced processes for monitoring and regulation of industrial units. In one advanced monitoring process according to the vocabulary of one skilled in the art, the industrial unit that is to be regulated is represented by a model that makes it possible to anticipate the actions to be implemented by reaching a level of finesse over the corrective actions that regulation by means of simple PIDF [Presence Information Data Format] does not make possible.

The model that represents the unit is generally a dynamic and linear model in the sense that the output magnitudes are connected to the input magnitudes by a linear-equation system. The representation of the model is therefore done naturally by means of a matrix, and the object of the operation that is called identification is to find the best set of coefficients of the matrix that is representative of the model. To ensure the identification phase, a multi-variable, predictive linear monitor is used in this invention.

More specifically, the acquisition of data necessary to the identification is done in a closed loop, i.e., while the monitor controls the industrial unit, which makes it possible to reduce the possibly substandard production time of the unit.

Within the context of this invention, a model of an industrial unit is called a representation of the behavior of the unit by means of a set of equations that connect the input variables (MV), the state variables (X), and the output variables (CV) of the unit.

The described identification phase applies to models that have a linear shape. Linear shape is defined as the fact that the variations of the input variables (MV), the state variables (X), and the variations of the output variables (CV) are linked to one another by the general equations of a stationary linear dynamic model (abbreviated MDL):

dX/dt=AX+B(MV)

(CV)=CX+D(MV)

The MDL model therefore characterizes the changes in the time derivative of X as a linear application relative to X and relative to MV. In a similar way, the changes of CV are described by a linear application relative to X and relative to MV.

The MV are, for example, the feedstock flow rates, flow rates of use, the temperature of the feedstock, etc.

The CV are, for example, the conversion, and the content of certain components.

The state variables are represented by X and can be defined as any magnitude that makes it possible to describe the unit at each instant (temperature, pressure, composition of the flows that circulate in the unit . . . ).

The multi-variable, predictive linear monitor (called MVAC in the text below) works in a closed loop; i.e., from the measurement of all or part of the CV and their comparison relative to the set objectives (set values, high and low limits), it calculates and applies to the industrial unit the values of the MV that are required to reach or maintain the objectives for the CV.

To execute its calculations, the MVAC monitor uses an approximate description of the behavior of the process in the form of an MDL model that is referred to as M(n) in the text below. The index (n) indicates that the model is reached at the end of a certain number of iterations from an initial M0 model that can be relatively removed from the behavior of the industrial unit.

The MDL model is entirely characterized by the four matrices A, B, C and D.

From the writing of these equations, taking into account couplings between the input, output and state variables is intrinsic. Thus, an MV can activate one or more components of the state X and by the same token activate several CV at a time. As an alternative, an MV can act directly on several CV at a time (matrix D). The operation that is called “identification,” or identification phase, consists in calculating the value of the coefficients of the four matrices A, B, C and D that are used in the model.

This operation is automatically executed by identification software that is called ISIAC from a set of data that is characterized by the measurements of the MV and CV. The expression “data set” refers to one or more recordings over time of input variables MV(t) and output variables CV(t). Such a recording is called a collection. A collection is to be carried out at a minimum over an interval of time of greater than the dynamic response of the slowest CV.

Actually, it is desirable that after a transitional period, corresponding to the variation of the CV following one or more variations of the MV, the collection continues until the measured CV are stabilized. Furthermore, to be exploitable by the identification software ISIAC, a collection is to contain enough frequency information, i.e., to use measured variations of the CV that are more important than those due to the noise associated with the sensors that ensure the measurement of these variables.

### EXAMINATION OF THE PRIOR ART

The prior art in the field of operations for identification of the process in a closed loop is essentially represented by the U.S. Pat. No. 6,819,964, which describes a method that is based on the use of hidden variables (called “shadow system controlled variables” in the cited patent). To be applied, this method requires a modification of the structure of the model that is used by the monitor.

The method that is used in this application is a method for identification of the process in a closed loop, characterized by the fact that it does not make use of any hidden variable, which differentiates it significantly from the method that is described in the U.S. Pat. No. 6,819,964. It rests on a particular use of a functionality that is available in the MVAC monitor, a functionality called an external target for the MV (translation of “outside targets”).

This functionality of the MVAC monitor, which can be used without any modification of the structure of the MDL model, makes it possible, when this is possible, to simply orient the MV to specified objects, while continuing to satisfy the objectives of the CV in order of priority. Furthermore, MVAC makes it possible to reach the targets that are defined on the MV as quickly as desired.

Finally, contrary to the method that is described in the U.S. Pat. No. 6,819,964, it is not necessary according to the invention to verify the state of the CV relative to their objective before initiating the procedure for modification of the MV.

### SUMMARY DESCRIPTION OF THE FIGURES

FIG. 1 shows a functional diagram of the process that is used in Example 1 that comprises two input magnitudes (MV1) and (MV2) and one output magnitude (CV).

FIG. 2 shows a diagram of the process during identification with the MVAC monitor connected to the process in a closed loop and supplied by two so-called “external target” magnitudes (ET1) and (ET2).

FIG. 3 shows three graphs that are designed to illustrate the identification operation: the upper graph corresponds to the variation of (CV) over time, the intermediate graph corresponds to the variation of (MV1), and the lower graph corresponds to the variation of (MV2). The legend of these three graphs is provided in the example itself.

### SUMMARY DESCRIPTION OF THE INVENTION

This invention can be defined as a process for advanced monitoring and regulation that can be applied to any industrial unit that has input magnitudes and output magnitudes that are connected to one another in a linear manner: i.e., a unit that can be represented by a linear model that connects the input and output magnitudes, as defined in the preceding paragraph.

The process for monitoring and regulation employs a phase (or operation) for identification of the parameters of the linear dynamic model that represents the industrial unit. This process for monitoring and regulation is particularly suitable for industrial units that have to ensure a uniform production over time that complies with various constraints on the products that are obtained. Among these constraints, it is possible to cite the purity level, for example the sulfur content in a hydrodesulfurization process, or the value of a characteristic, such as, for example, the octane number of a gasoline in a catalytic reforming unit of gasolines, or else the cracking temperature in a catalytic cracking unit that is designed to produce bases for gasoline or in a particular method of operation of the propylene.

The difficulty in the identification operation that is applied to industrial units is to quickly obtain optimum values of the parameters of the model of the unit by disrupting production as little as possible.

The MVAC monitor that is used in the identification operation according to this invention offers a so-called “external target” functionality that makes it possible to apply variations of input variables MV by integrating one or more criteria to abide by the constraints on the output variables CV, whereby these criteria are always of utmost importance. In this way, the production constraints are always observed.

Furthermore, this identification operation includes a relatively fine iteration criterion that makes it possible to resume the iteration when this is necessary for a determined stage of the course of said operation.

More specifically, this invention can be defined as a process for advanced monitoring of an industrial unit that employs an operation for identification of the parameters of the linear dynamic model of said unit, whereby said identification operation is carried out in a closed loop and employs a monitor (MVAC) and identification software (ISIAC) and said identification operation consists in the following series of stages:
1 Initialization stage, in which the ISIAC software generates a first process model (M0), a model that is later used by the MVAC monitor to control the industrial unit, from data collected via manual modifications by the operator,
2 Stage for generation of MV variations, in which, offline, i.e., without a connection to the current operation of the industrial unit, ISIAC generates variations for each MV, whereby these variations for each MV consist of a series of increments and decrements, spaced in a manner that may or may not be uniform, and with amplitudes such that they induce measurable variations of all or part of the CV,
3 Stage for validation of the variations of the MV and regulation of the MVAC monitor, in which, offline, simulations of the behavior of the unit that is controlled by the MVAC monitor are implemented by connecting the MVAC monitor to a dynamic simulator, which approximately reproduces the operation of the unit and by using the M(n) model that is available in this stage, whereby the variations that are defined in stage 2 are implemented in simulation via the MVAC “external target” functionality, whereby the amplitudes of the variations over the MV defined in stage 2 are adjusted, the objectives on the CV are relaxed, and the regulation of the monitor is refined by intervention of an operator,
4 Stage for generating responses from the industrial unit, in which the MVAC monitor as regulated at the output of stage 3 is connected to the industrial unit in a closed loop and automatically applies to the industrial unit the variations that are defined on the MV in stage 3, via the “external target” functionality,
5 Stage for generating parameters via ISIAC, in which, offline, the ISIAC identification software calculates the parameters of the model from data generated in stage 4,
6 Stage for evaluating the precision of the model, in which the ISIAC identification software implements a calculation of the precision of the parameters that are obtained at the output of stage 5 starting from a criterion that makes it possible to decide a) the stopping of the iterations if the precision is satisfactory; b) the iteration starting from stage 2 if the precision on one or more parameters is insufficient; c) the iteration from stage 4 in the case where the imprecision is obtained from disruptions of the operation of the unit during the application of the variations on the MV.

The process for monitoring and regulation according to the invention can apply to a unit for hydrodesulfurization of a gasoline- or gas-oil-type hydrocarbon feedstock, in which the input magnitudes are the feed rate (MV1) of the unit and the temperature at the inlet of the hydrodesulfurization unit (MV2), and the output magnitude (CV) is the sulfur content of the gasoline or treated gas oil.

The process for monitoring and regulation according to the invention can also apply to a unit for hydrogenation of olefinic gasolines that are obtained from a catalytic cracking process in which the input magnitudes are the flow rate of hydrogen (MV1) and the flow rate of cold fluid that is intended to block the reactions (MV2), and the output magnitudes are the styrene content at the outlet of the unit (CV1) and the temperature difference between the outlet and the inlet of the unit (CV2).

This process can be applied to any unit that has input variables (MV) and output variables (CV) and whose behavior can be represented by a linear model.

Among the refining units, it is possible to cite by way of example, without this being limiting,
A unit for hydrodesulfurization of a gasoline- or gas-oil-type hydrocarbon feedstock, in which the input magnitudes are the feed rate (MV1) of the unit, and the temperature at the inlet of the hydrodesulfurization unit (MV2), and the output magnitude (CV) is the sulfur content of the gasoline or the gas oil that is treated.
A unit for hydrogenation of olefinic gasolines that are obtained from a catalytic cracking process, in which the input magnitudes are the hydrogen flow rate (MV1) and the flow rate of cold fluid that is intended to block the reactions (MV2), and the output magnitudes are the styrene content at the outlet of the unit (CV1) and the temperature difference between the outlet and the inlet of the unit (CV2).

### DETAILED DESCRIPTION OF THE INVENTION

More specifically, the process for monitoring and advanced regulation of this invention employs a phase for identification of parameters of a linear model that represents the behavior of the industrial unit that has to be regulated.

The identification phase of the parameters of the model of the unit employs a linear, multi-variable predictive monitor (MVAC) that periodically solves with a period T (typically on the order of 1 minute)—a problem of quadratic form, i.e., a form that contains a quadratic criterion relative to the optimization variables. Quadratic form is defined as a mathematical expression that employs the square of optimization variables.

Furthermore, the input magnitudes MV are to observe a certain number of constraints.

The optimization variables are a set of future values that the MV should assume so that the constraints are observed as well as possible and so that said quadratic criterion is minimized. For each MV, denoted MVi, there is found in this set the value to be applied to the industrial unit at the moment immediately following the calculation that is made MVi(O), as well as values to be applied later, with different multiples of the period T, MVi(xT), whereby x belongs to an increasing series of integers.

From this set of calculated values, only the MVi(O) are actually applied to the process.

A new optimization problem is solved in the following period.

The linear constraints of the optimization problem can make it possible to ensure as well as possible that:
The MV remain between the specific minimum and maximum limits;
The variations of the MV from one interaction to the next remain between specified minimum and maximum limits;
The CV remain between specified minimum and maximum limits.

The quadratic criterion of the optimization problem can comprise the addition of several terms:
Terms impairing the deviation between the CV and the desired paths that are assigned to them;
Terms impairing the variation of the MV from one iteration to the next (terms that are used in conjunction or not with the variation constraints of the MV);
Terms impairing the deviation between the MV and the desired paths that are assigned to them. In the MVAC monitor, these desired paths for the MV effectively exist and are informed by the magnitudes called “external targets.”

In the text below, we use the following notations:

MDL refers to the linear dynamic model that represents the behavior of the unit that is to be regulated.

MVAC refers to the multivariable, predictive linear monitor that is entirely compatible with the identification phase in a closed loop.

ISIAC refers to the identification software, i.e., calculation of the parameters of the MDL model. The ISIAC software is also used to generate the values of the input variables that are to be applied to the process during the data collection phase. These values are obtained, for example, from pseudo-random binary sequences (SBPA) and are determined for demonstrating the entire frequency spectrum of the process and for showing all of the couplings that can exist between the variables.

An SPBA is a series of rectangular pulses of random length and zero means, which makes it possible to approximate a discrete white noise. It is therefore a frequency-rich signal, particularly well-suited for revealing the frequency spectrum of a process.

The identification phase of the parameters of the MDL model of the unit, forming part of this invention, rests on 6 stages:
1. Initialization of the model: Starting from data collected via manual modifications made by the operator on MV set values, the ISIAC software generates a first model (M0) of the unit that is to be regulated. This model is later used by the MVAC monitor to control the unit. During this initialization phase, the MVAC monitor is not used on the industrial unit.
2. Generation of the MV variations: Offline, i.e., without a connection with the operation of the actual process, ISIAC generates variations for each MV. These variations are calculated for demonstrating the frequency spectrum of the unit and for showing the couplings between the variables. These are, for example, SBPA-type sequences that are superposed on current values of the MV. More generally, these variations for each MV are a series of increments and decrements, spaced uniformly or not, and amplitudes such that they induce measurable variations of all or part of the CV. Measurable is defined as the fact that the variations of measurements of the CV, following MV variations, are more significant than the variations that are linked to the measuring noise (itself linked to the technology of the sensor that is used).
3. Validation of the Variations that are Generated and Regulation of the MVAC Monitor:
   Offline, simulations of the behavior of the unit that is controlled by the MVAC monitor are implemented. For this purpose, the MVAC monitor is connected to a dynamic simulator, which approximately reproduces the operation of the unit by using the MDL model that is available in the stage under consideration, or M(n). The variations that are defined in stage 2 are implemented in simulation via the MVAC “external target” functionality. Their effects on the CV are displayed and analyzed by a process monitoring engineer. The amplitudes of the variations on the MV that are defined in stage 2 can be adjusted, and the regulation of the MVAC monitor can be refined. These adjustments and regulations contain in particular a phase for relaxation of the objective for the CV.
   Relaxation is defined as the fact of transforming set points into low and high limits, increasing the value of maximum limits and reducing the values of minimum limits.
   All of these operations are implemented so that the new values of the limits are compatible with a reliable operation of the unit, whereby the specifications on the products are furthermore guaranteed. This relaxation of the objectives has as its object to make possible more significant variations of the MV, leading to CV variations that are themselves significant enough so that the information contained in the collected data has an adequate signal-to-noise ratio.
   It is a matter of a relatively standard aspect in the processing of information that will not be more developed.
4. Application of the MV Variations to the Actual Process and Collection of Data:
   In this stage, the MVAC monitor is connected to the unit.
   MVAC, as regulated at the output of stage 3, automatically applies to the unit of the defined and refined variations on the MV in stage 3, via the “external target” functionality. Since MVAC is looped in the unit, reaching the objectives on the CV (i.e., the observation of various constraints) remains a priority. It is this that makes it possible to preserve production with the required specifications throughout this stage.
5. Generation of the Parameters of the Process: Offline, ISIAC calculates the parameters of the MDL model of the unit from data generated in stage 4.
6. Evaluation of the Precision of the Model: Offline, ISIAC provides indications on the precision of the model that is obtained at the output of stage 4. These indications are constructed in the following manner:
   yj(t) is a subassembly of the values taken by the measurement of the CVj, during the collection phase in stage 4, subassembly comprising the values that are used for the identification by ISIAC in stage 5. moy(yj(t)) is the mean of the values of yj(t). ypj(t) is the predicted value for these values yj(t), starting from the model that is developed by ISIAC in stage 5.
   The indication on the precision of the model for the CVj is calculated as the difference between 1 and the quotient between the Euclidean standard of the deviation between yj(t) and ypj(t) and the Euclidean standard of the deviation between yj(t) and moy(yj(t)).
   If the model is perfect, the deviation between measurement and prediction is zero and the indicator is equal to 1.
   When the prediction does not provide information other than the mean value moy(yj(t)), in other words that it is of very poor quality, the indicator is equal to 0. This functionality makes it possible to give a ruling on the necessity for continuing the tests.
   If ISIAC indicates that one or more parameters of the model are inaccurate, stages 2 to 4, or simply stage 4, are begun again in the event where the inaccuracy originates from disruptions of the operation of the process during the application of the variations on the MV. This latter case is identified by the examination, on the collected data, of the ratio between, on the one hand, the time passed by the MV on the objectives that are defined in stages 2 and 3, and, on the other hand, the total collection time. For the iteration of stages, the M(n) model that contains the last reliable parameters that are obtained at the output of stage 5 is used.

### EXAMPLES ACCORDING TO THE INVENTION

### Example 1

The first example that is presented relates to the process for monitoring and advanced regulation of a unit for hydrodesulfurization of gasolines.

The model of this unit comprises an output magnitude CV, the sulfur content at the outlet of the unit. Its measurement is not very frequent and noisy.

The model comprises two input magnitudes MV1, the feed rate of the unit and MV2, the temperature at the inlet of the hydrodesulfurization reactor.

Of course, the fact that the model of this example comprises only two input variables and one output variable is not at all limiting, and this process for monitoring and regulation applies in the same way to systems that comprise any number of input variables and output variables.

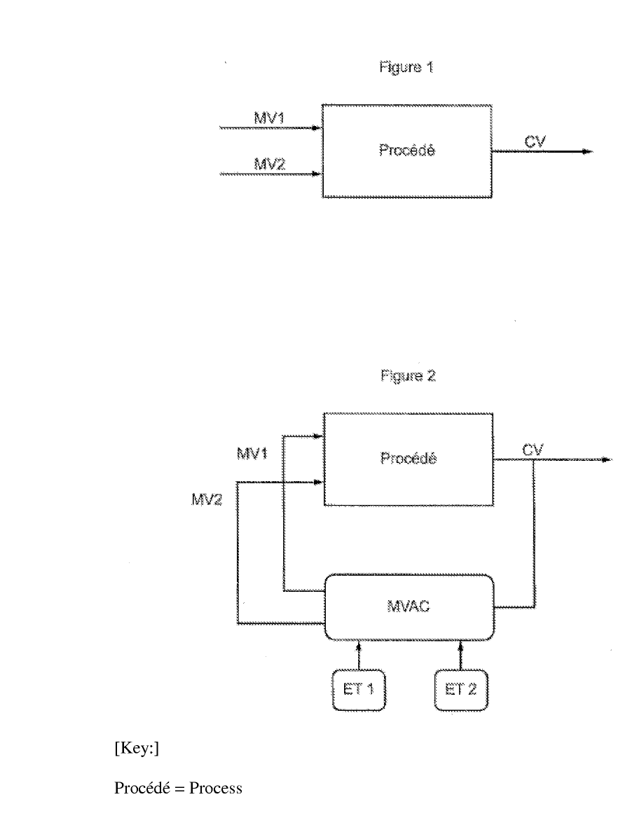

The functional diagram of the hydrodesulfurization unit is such as presented in FIG. 1.

The two input variables MV1 and MV2 activate the CV; there is therefore a coupling. It is presumed that the initial model that is used in MVAC (M(0)) is very removed from the process.

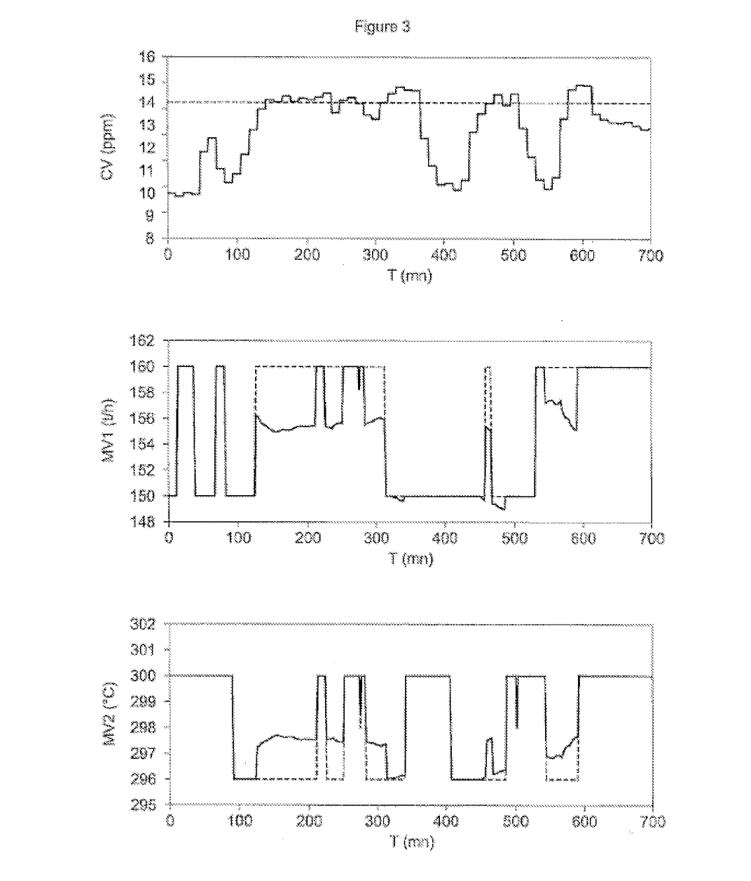

FIG. 3 shows the advantage of the looping of the MVAC monitor for the identification phases. Variations have been calculated with ISIAC (stages 2 and 3) and are applied to each of the MV with the looped monitor (stage 4).

The objectives on the CV have been reduced to a maximum constraint to not be exceeded (CV less than maximum CV).

In the present case with two MV, and taking into account response times of the process, a test of the agenda makes it possible to obtain the information that is necessary to the calculation of a new MDL model.

Three graphs are presented in FIG. 3:
The upper graph shows the changes over time of the measurement of the CV based on time. Time (T) is on the abscissa and uses the minute as a unit. The CV is the sulfur content measured in ppm.

The actual measurement that comprises noise and possible disruptions is shown in solid lines. The maximum constraint that is not to be exceeded is shown in dotted lines (14.3 ppm).

The graph of the medium shows the changes based on time of the MV1.

Time (T) is on the abscissa and uses the minute as a unit. The MV1 is the feedstock flow rate measured in tons/hour (t/h).

The value of the variation calculated in stages 2 and 3 for the “external target” functionality is shown in dotted lines.

The value that is actually applied to the hydrodesulfurization unit is shown in solid lines. These two values differ when the MVAC monitor is to modify the MV for meeting the priority objectives of the CV.

The graph of the bottom shows the changes based on time of the MV2.

Time (T) is on the abscissa with the minute as a unit. The MV2 is the input temperature in the reactor at ° C.

The value of the variation that is calculated in stages 2 and 3 is shown in dotted lines.

The value that is actually applied to the unit is shown in solid lines. These two values differ when the MVAC monitor is to modify the MV to meet the priority objectives of the CV.

The disclosed case corresponds to the operation according to FIG. 2 (the ET acronym is used to refer to the external target functionality):

The values to be reached by the MV (variations calculated in stages 2 and 3) are assigned to the MVAC inputs according to the “external target” functionality. The MVAC monitor then calculates the values of the MV to be applied to the unit while ensuring that the CV satisfies the objectives.

In this example, the following are placed under difficult conditions:
The measurement of the CV is not very frequent and noisy;
The initial model that is used in MVAC is removed from the process model.

The lower measurement frequency is characterized by bearings that show the absence of new information for a certain time. This can be, for example, the time for analysis of a sulfurimeter (specific equipment for the measurement of sulfur) or a chromatograph.

The variations on the MV are applied in a closed loop according to the invention (stage 4), i.e., the objective on the CV continues to be a priority during the identification phase. It is seen that the measured value of the CV is little removed from its maximum constraint and that the MV quickly reach the desired and defined values during stages 2 and 3.

In the presence of not very frequent and noisy measurements, the application of the process for monitoring and regulation according to the invention leads to results that constitute progress relative to the prior art:
1. Substandard production remains low.
2. The value of the MV is readjusted automatically but the stiffness of the fronts is preserved and therefore the signal maintains good characteristics for identification. As soon as possible, the controls return very quickly to the values that are defined during stages 2 and 3.

### Example 2

The second example is qualitative so as not to multiply the figures that are of the same type as those relative to Example 1.

This example relates to the simplified monitoring of a unit for hydrogenation of gasolines. In this unit, the feedstock has a relatively large content of unsaturated compounds and is brought into contact with a catalyst in the presence of hydrogen. Under conventional hydrogenation conditions (temperature of between 250° C. and 350° C., pressure between 20 and 50 bar with a catalyst that is based on Co/Mo or Ni/Mo on the alumina substrate), the unsaturated compounds of the feedstock are hydrogenated. This hydrogenation reaction is exothermic, and it is suitable for blocking the reactions by a coolant to prevent parasitic cracking reactions or the like.

The feedstock flow rate as well as the temperature at the inlet of the hydrogenation reactor are constant.

The monitor activates the hydrogen flow that constitutes the first input variable (MV1) and the flow of cold fluid that is intended to block the reactions, which constitutes the second variable MV2.

The control diagram comprises two output magnitudes CV.

The first CV that is called CV1 is the styrene content at the outlet of the reactor. This is a variable that constitutes a good image of the content of unsaturated compounds that remain after the hydrogenation reaction. This CV1 should remain around a fixed reference value, but, during the identification phases, it can vary between fixed end points.

The second CV, called CV2, is the temperature difference between the outlet and the inlet of the reactor. This variable is to remain lower than a fixed maximum so as to protect the catalyst and to ensure stable operation of the reactor.

One increment of the MV1, the hydrogen flow rate, tends to promote the reaction by increasing the partial hydrogen pressure. In this case, the styrene content decreases, and the temperature difference between outlet and inlet of the reactor increases.

One increment of the MV2, the flow rate of cold fluid, has a tendency to reduce the temperature difference to the detriment of the reaction: the styrene content increases. The functional diagram of this process with two MV and two CV is analogous to the one that is presented in FIG. 1 with an additional MV, or MV2.

The two input variables, MV1 and MV2, activate the two output variables CV1 and CV2. It is assumed that the model that is used in MVAC (M(0)) is very removed from the process.

The problems that arise when the invention is not implemented, i.e., when the MVAC monitor is not looped, are problems where boundary values or target values are exceeded.

The variations for the MV can induce a violation of priority objectives for the CV. The end points for the CV1 can be violated. Likewise, the maximum for the CV2 can be exceeded. This situation is accompanied by a substandard production that can obviously be damaged on the economic plane.

The advantage of looping the MVAC monitor during the identification phases resides in the observation of all of the constraints that therefore makes possible a production in accordance with the specifications.

The variations have been calculated with ISIAC (stages 2 and 3) and are applied to each of the MV with the looped monitor (stage 4).

The objectives on the CV1 have been transformed into minimum and maximum constraints that are not be exceeded (CV less than maximum CV and greater than minimum CV, stage 3).

In the case of this example with two MV, for a process with a response time on the order of several tens of minutes, a test on the order of eight hours makes it possible to obtain the necessary information for the calculation of a new MDL model and the one with a production that observes the specifications on the entire period of the identification.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding French application Ser. No. 09/00531, filed Feb. 6, 2009, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. Process for monitoring and advanced regulation of an industrial unit that is represented by a linear dynamic MDL model, having so-called MV input magnitudes and so-called CV output magnitudes, whereby said process operates in a closed loop and employs a phase for identification of parameters of the MDL model that is carried out by means of a monitor (MVAC) and identification software (ISIAC) and that consists in the following series of stages:
A stage 1 for initialization in which the ISIAC software generates a first model (M0) of the industrial unit, a model that is later used by the MVAC monitor to control said unit, from data collected via manual modifications by the operator.
A stage 2 for generation of MV variations in which, offline, i.e., without a connection to the operation of the unit, ISIAC generates variations for each MV, whereby these variations for each MV consist of a series of increments and decrements of amplitudes such that they induce measurable variations of all or part of the CV.
A stage 3 for validation of the variations of MV and for regulation of the MVAC monitor in which, offline, simulations of the behavior of the unit that is controlled by the MVAC monitor are implemented by connecting the MVAC monitor to a dynamic simulator, which approximately reproduces the operation of said unit, and by using the M(n) model that is available in this stage, whereby the variations that are defined in stage 2 are implemented in simulation via the MVAC “external target” functionality, whereby the amplitudes of the variations over the MV defined in stage 2 are adjusted, the objectives for the CV are relaxed, and the regulation of the monitor is refined by intervention of an operator.
A stage 4 for generating responses from the unit in which the MVAC monitor, as regulated at the output of stage 3, is connected to said closed-loop unit and applies automatically to the unit the variations that are defined in the MV in stage 3, via the “external target” functionality.
A stage 5 for generating parameters via ISIAC, in which, offline, the ISIAC identification software calculates the parameters of the model of the unit from data generated in stage 4.
A stage 6 for evaluating the precision of the model, in which the ISIAC identification software implements a calculation of the precision of the parameters that are obtained at the output of stage 5 starting from a criterion that makes it possible to decide a) the stopping of the iterations if the precision is satisfactory; b) the iteration starting from stage 2 if the precision on one or more parameters is insufficient; c) the iteration starting from stage 4 in the case where the imprecision originates from disruptions of the operation of the unit during the application of the variations on the MV.

2. Process for monitoring and advanced regulation of an industrial unit according to claim 1 that employs a phase for identification of the parameters of an MDL model of said unit in which the signals that are generated by ISIAC during stage 2 are pseudo-random binary sequence-type signals (SBPA) that are applied directly to the MVAC monitor.

3. Process for monitoring and advanced regulation of an industrial unit according to claim 1 that employs a phase for an identification of the parameters of an MDL model of said unit, in which the iteration criterion that is used in stage 6 that triggers a return to stage 4 is defined by the ratio between, on the one hand, the time that has passed by the MV on the objectives that are defined in stages 2 and 3, and, on the other hand, the total collection time, whereby said iteration is carried out from the MDL(n) model that contains the last reliable parameters that are obtained at the output of stage 5.

4. Application of the process for monitoring and regulation according to claim 1 to a unit for hydrodesulfurization of a gasoline- or gas-oil-type hydrocarbon feedstock, in which the input magnitudes are the feed rate (MV1) of the unit and the temperature at the inlet of the hydrodesulfurization unit (MV2), and the output magnitude (CV) is the sulfur content of the treated gasoline or gas oil.

5. Application of the process for monitoring and regulation according to claim 1 to a unit for hydrogenation of olefinic gasolines that are obtained from a catalytic cracking process in which the input magnitudes are the flow rate of hydrogen (MV1) and the flow rate of cold fluid intended to block the reactions (MV2), and the output magnitudes are the styrene content at the outlet of the unit (CV1) and the temperature difference between the outlet and the inlet of the unit (CV2).
